(19) United States
(12) Patent Application Publication
(10) Pub. No.: US 2004/0208296 A1
(43) Pub. Date: Oct. 21, 2004

(54) Automatic telecommunications service notification

(76) Inventors: Roger B. Aboujaoude, Ocean Township, NJ (US); Gail L. Bennett, Jersey City, NJ (US); Hossein Eslambolchi, Los Altos Hills, CA (US); Darlene Bing Major, Jonesboro, GA (US); James H. Milk, Long Valley, NJ (US); Kenneth Ray Montell, Castro Valley, CA (US); Jamie C. Montero, Tinton Falls, NJ (US)

Correspondence Address: AT&T CORP., P.O. BOX 4110, MIDDLETOWN, NJ, 07748, US

(21) Appl. No.: 10/417,362

(22) Filed: Apr. 16, 2003

(51) Int. Cl. H04M 1/64

(52) U.S. Cl. 379/88.12; 379/88.11

(57) ABSTRACT

An automatic notification system for certain telecommunications service applications allows for prompt and efficient “status item” notification messages to be sent to service subscribers without human intervention. A notification system application platform is configured to recognize certain trigger events (such as, for example, the completion of a line test) and retrieve subscriber information from a database regarding a preferred communication channel for receiving status item notification messages. The platform then automatically transmits the proper message to the subscriber (sending an email notification as a default channel) and, if appropriate, waits for a reply message from the subscriber. The “subscriber” may also include a company such as an access provider, which may receive notification regarding access tests formed in the network.

### TECHNICAL FIELD

The present invention relates to an automatic telecommunications service notification procedure and, more particularly, to a method for automatically notifying subscribers regarding certain “events” associated with their telecommunications service.

### BACKGROUND OF THE INVENTION

Many aspects in the provisioning and maintenance of telecommunications service require communication between the service provider and a subscriber. For example, when service needs to be terminated or moved to another location, the subscriber needs to contact the service provider. When there is problem with the telecommunications line itself, the service provider must performing testing on the line to determine the problem(s) within the line or other equipment and then contact the subscriber with the results of the testing. A variety of messages are often communicated between a service provider and subscriber when new services and/or equipment are/is being purchased and installed.

Heretofore, many of these “status” communications required one or more service specialists within the telecommunications company to individually contact each subscriber, many times merely delivering “status/update” information or “test/complete” information that includes little, if any, substantive detail. The utilization of telecommunications service specialists to deliver this type of information is considered to be an inefficient use of a trained resource and results in increasing the cost and inefficiency of various telecommunications services.

Thus, a need remains in the art for a system of relying messages between a telecommunications service provider and subscribers that improves both the cost and efficiency of such services.

### SUMMARY OF THE INVENTION

The need remaining in the art is addressed by the present invention, which relates to automatic telecommunications service notification and, more particularly, to a method for automatically notifying subscribers regarding certain status “events” associated with their telecommunications service.

In accordance with the present invention, a network-based application includes a database of subscriber preferences regarding notification processing. In most cases, the application will first contact a subscriber via a telephone call to report a particular “status item” notification (“status item” referring, in general, to any information that can be supplied to a subscriber regarding a particular service, such as “new service” ready or “end-to-end test” completed, or apparatus, such as “delivery date” information for equipment, and the like). Alternatively, the subscriber may request an email notification (or fax notification, PDA notification, etc.). Presuming the subscriber has requested a telephone call notification for “status item” information, the call may follow one of three possible scenarios: (1) busy; (2) ring—no answer; or (3) answered, where different processes are then followed depending on which scenario unfolds.

The notification process of the present invention is equally applicable in situations where the “subscriber” is an access provider, with the network performing access tests, then automatically transmitting the results of the tests to a designated individual associated with the access provider.

In any particular process, the subscriber may always elect to speak directly with service representative if there are any questions or issues associated with the particular “status item” that was transmitted.

Other and further aspects and features of the inventive event notification system will become obvious during the course of the following discussion and by reference to the accompanying drawings.

### BRIEF DESCRIPTION OF THE DRAWING

Referring now to the drawings,

FIG. 1 illustrates, in simplified form, an exemplary telecommunications network arrangement that may be utilized to implement the automatic notification procedure of the present invention;

FIG. 2 contains an exemplary database arrangement that may be used to manage the subscriber notification procedure of the present invention; and

FIG. 3 is a flowchart of an exemplary process for implementing the automatic notification procedure of the present invention.

### DETAILED DESCRIPTION

FIG. 1 illustrates, in simplified form, an exemplary telecommunications network 10 that may be used to implement the automatic service notification procedure of the present invention. In the particular arrangement as shown in FIG. 1, the telecommunications service is provided over the public switched telecommunications network (PSTN) 12; however, it is to be understood that the operation of the present invention may be provided over a private network, data network, or any other suitable network used to provide telecommunications service. Referring back to FIG. 1, a notification system services application platform 14 is coupled to network 12 and is used to control the oversight of various telecommunications functions performed by a particular service provider. As mentioned above, various events occurring during the provision of these services may result in the need to transmit “status item” notifications to subscribers. For example, subscriber notifications are possible regarding the delivery status of various pieces of equipment associated with provisioning of service, pre-disconnect notification, customer vendor dispatch notification, completion of testing notification, acceptance of service notification, supply chain management certification, and the like.

Referring back to FIG. 1, notification system platform 14 is used to monitor various activities associated with one or more of these operations and determine the appropriate “events” that trigger the need to transmit a “status item” notification to a subscriber. For example, when an end-to-end test has been administered between a subscriber terminal (such as telephone 16), a local switch 18 and PSTN 12, the results of the test may be directly communicated to the subscriber (e.g., “test completed; line in service”). Alternatively, when a new PBX system has been received by the service provider and is ready to be shipped to a business client 20, the notification procedure of the present invention may be used to contact client 20 (via a telephone call or email, as the preference is dictated) and schedule a delivery date.

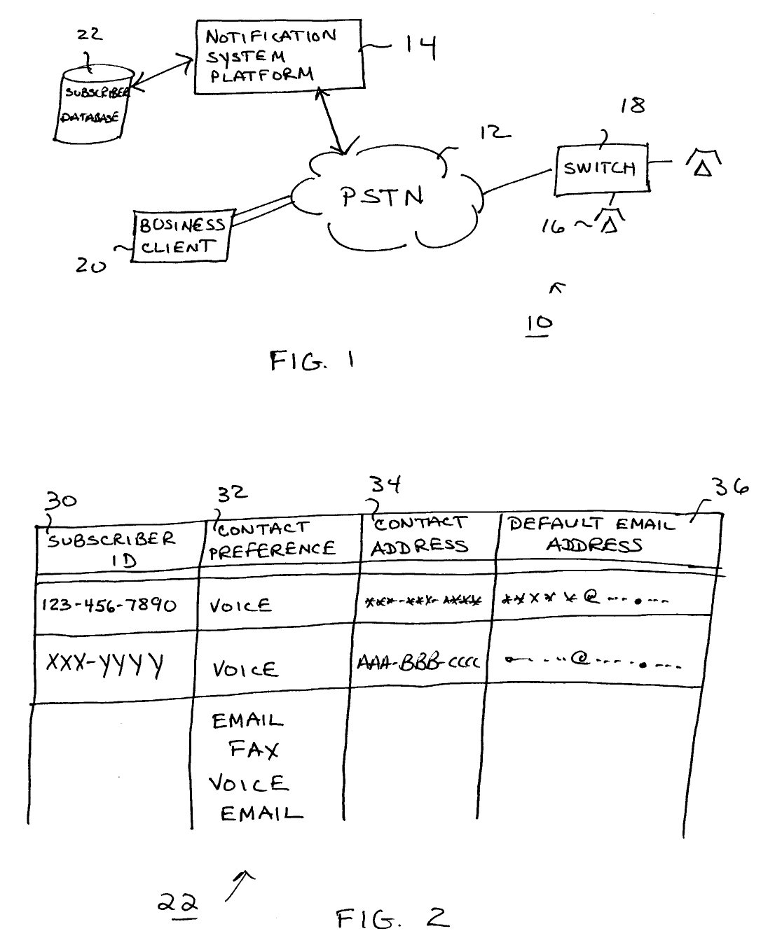

In order to utilize the notification procedure system of the present invention, a customer must first make a determination to become a registered subscriber for this service and submit his contact information. A network-based database 22 is used to store this preferred contact information for each subscriber to the notification procedure. As mentioned above, an organization such as an access provider may also be a “subscriber”, where database 22 will also store this information, including a designated individual associated with the organization to contact with the status information. As shown in FIG. 1, when notification system platform 14 recognizes the need to transmit a notification message (as triggered by a particular event), platform 14 will access database 22, using the subscriber ID information (such as, for example, the subscriber's telephone number—although other suitable ID information may be used). FIG. 2 illustrates an exemplary organization of database 22, including a first field 30 of subscriber ID information and a second field 32 of the subscriber's contact preference. That is, a particular customer may prefer to receive the “status item” notification via email instead of via a telephone call. Other methods of notification may include sending the information to the subscriber's PDA, fax machine, or the like. Associated with each preferred notification channel is the “address”/telephone number associated with that channel, listed in field 34 of database 22. For example, with customer ID XXX-YYYY, the contact preference is listed as “voice”, with telephone number AAA-BBB-CCCC as the number to call with the “status item” notification, where that number may be associated with a company's account representative, or an individual subscriber, or any other appropriate personnel.

As will be discussed below, if the primary notification channel listed in field 32 is other than email and may be unreachable at times, an email address is also listed (see field 36) as the default channel of communication for sending notification to the subscriber. Thus, all notification messages are sent using an appropriate communication channel, without the need for a telecommunications company representative to personally place a call to the subscriber. This results in a more efficient use of the company resources, as well as a higher confidence level in ensuring that the message has been delivered to the subscriber.

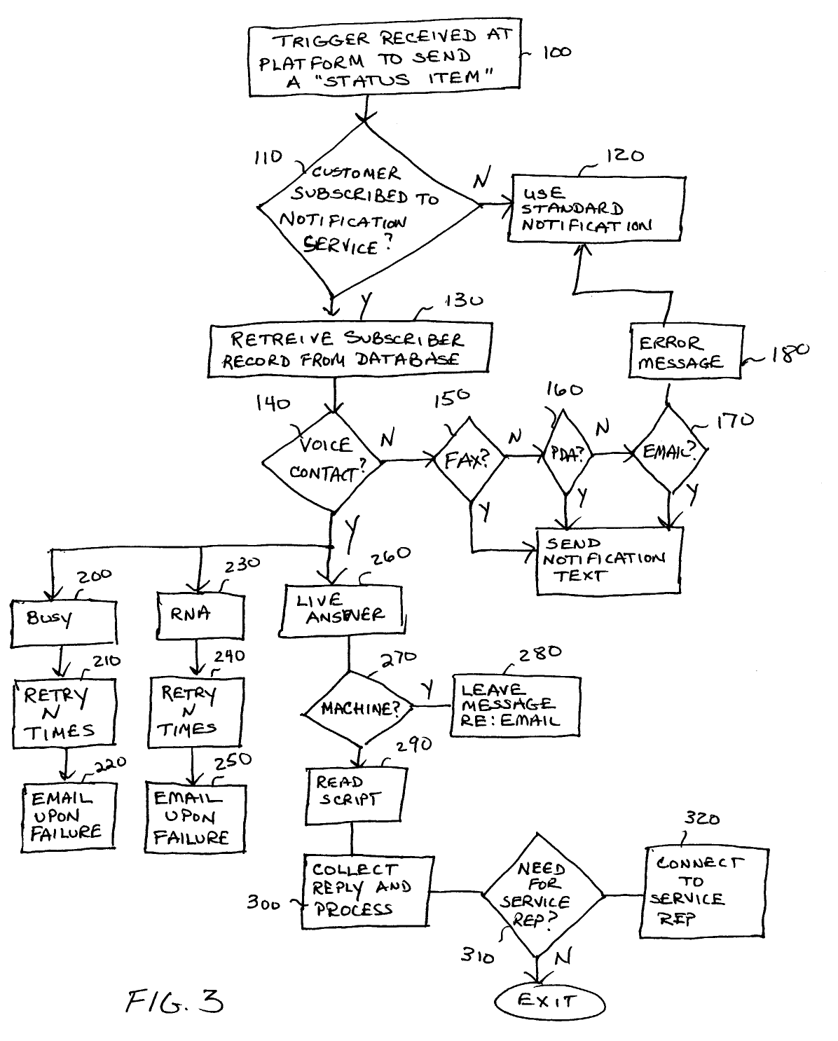

FIG. 3 contains an exemplary flowchart illustrating one embodiment of the automatic notification procedure as used in accordance with the present invention. For the purpose of understanding the process flow of FIG. 3, it will be presumed that a residential subscriber has requested an “end-to-end” test of his telephone line to determine if there is a break or other malfunction on the line. It is further presumed that the test has been completed and the line is found to be problem-free. The notification procedure of the present invention is then used to convey the “status item” information to the subscriber that the line is “problem free”. The completion of the end-to-end test is recognized by notification system platform 14 (FIG. 1) as an event that triggers an occasion to send an automatic notification (step 100 of FIG. 3). When the trigger is first received, notification system platform 14 sends a query to database 22 to determine if the customer is also a subscriber to the automatic notification process (step 110). If the customer is not a subscriber, then a conventional notification process is used (step 120) to tell the customer that the test is completed (or, alternatively, no notification is sent at all to the customer). Presuming that the customer has subscribed to the notification service, the details of the subscriber's record are retrieved from database 22 (step 130).

A first determination is made (step 140) to see if the subscriber has requested a voice telephone call with notification information. If not, the process continues (step 150) to determine if a “fax” notification has been requested, or subsequently another communications medium (such as via a PDA (step 160), or email (step 170)). If the process does not recognize any of these alternatives as “preferred” by the subscriber, an error message is returned to application 14 (step 180), and the standard notification process is used (step 120). Presuming the subscriber has requested a conventional telephone call (as shown in field 32 within database 22), the notification telephone number is retrieved from field 34 and notification system platform 14 launches a call to this number. As shown in FIG. 3, three different scenarios are possible when placing a notification call. In the first scenario (step 200), a “busy” signal is encountered. The application will then try again every X minutes (where in one example X=5) for a maximum number of N attempts (step 210) (where N=12 in one example). If the number remains “busy” after N attempts, an email notification is sent to the subscriber (step 220). In the second scenario (step 230), notification system platform 14 encounters a “ring, no answer” at the dialed telephone number. As with the busy conditions, a number N of retries are attempted, every X minutes (step 240). Again, if there is no answer after time period NX, an email notification is sent (step 250). Preferably, a “live” answer condition is encountered at the dialed number (step 260), where the “live” answer is first analyzed to determine if the called party is an answering machine or the subscriber himself (step 270). If an answering machine picks up the call, notification system platform 14 plays a message requesting the subscriber to check his email for a status notification (step 280). Alternatively, if the subscriber answers the call, the particular notification script is read for the subscriber (step 290), and if a response is desired (e.g., “yes” to accept service, “no” to delay delivery, etc.), notification system platform 14 will collect either the speech or DTMF response(s) from the subscriber (step 300) and process accordingly. The subscriber may also be given the option (step 310) of speaking with a telecommunications service representative (i.e., “press 0 to speak with a technician”, step 320).

Referring back to steps 150-170, in each case, notification system platform 14 transmits a notification message to the subscriber via the desired communication channel (step 330) and is thereafter prepared to receive a reply (step 340) via any one of the associated communication channels (where, for example, a faxed notification could be followed with a fax reply or, alternatively, an email reply).

While various embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents.

What is claimed is:

1. An automatic notification system for use with a telecommunications network to transmit status notification messages to subscribers associated with a telecommunications service provider, the system comprising
a notification system platform, disposed in the telecommunications network, for interacting with one or more services offered by the telecommunications service provider and recognizing trigger events associated with the one or more services; and
a network database of subscribers to the notification system, the network database coupled to the notification system platform and including a separate record for each subscriber, each record including a preferred communication channel for transmitting notification messages from the notification system platform to the appropriate subscriber, wherein upon reception by the notification system platform of a trigger event, said notification system platform retrieves the associated subscriber record information from said network database and transmits a notification message to said subscriber over the preferred communication channel.

2. The automatic notification system as defined in claim 1 wherein each subscriber record in the network database further includes a subscriber email address to use as a default communication channel for notification messages.

3. The automatic notification system as defined in claim 1 wherein at least one subscriber record lists a telephone number as the preferred communication channel for notification messages.

4. The automatic notification system as defined in claim 1 wherein the subscriber is a communication access provider.

5. A method of automatically sending status item notification messages to customers of a telecommunications service provider, the method comprising the steps of:
recognizing, at a notification system application platform, the occurrence of a triggering event requiring the transmission of a status item notification message to a customer;
querying a network database to determine if the customer is also a subscriber to the service provider's automatic notification service and, if so,
retrieving the subscriber's record from the network database and finding the subscriber's preferred communication channel for receiving status item notification messages; and
sending the status notification message via the preferred communication channel.

6. The method as defined in claim 5 wherein the subscriber's record includes an email address for the subscriber and if the preferred communication channel is not available, the method performs the step of sending the status item notification message via an email message.

7. The method as defined in claim 5 wherein the method further comprises the steps of
waiting for a reply/verification message from the subscriber; and
forwarding the reply/verification message to the notification system application platform.

8. The method as defined in claim 5 wherein a subscriber's preferred communication channel is a voice channel telephone call, and upon the reception of a “busy” signal by the notification system application platform, the method comprises the additional steps of:
re-initiating a telephone call every X minutes over a time period of length N, where X and N are controlled by the application platform; and
if communication is established, forwarding the status item notification message, otherwise transmitting an email notification message at end of the predetermined time period.

9. The method as defined in claim 5 wherein a subscriber's preferred communication channel is a voice channel telephone call, and upon a first call attempt ending in a “ring, no answer” condition, the method comprises the additional steps of:
re-initiating a telephone call every X minutes over a time period of length N, where X and N are controlled by the application platform; and
if communication is established, forwarding the status item notification message, otherwise transmitting an email notification message at end of the predetermined time period.

10. The method as defined in claim 5 wherein a subscriber's preferred communication channel is a voice channel telephone call, and a live answer communication path is establishing between the subscriber and the notification system application platform, the method comprises the further steps of:
determining if the live answer is an answering machine and, if so, leaving a message that an email notification has been sent, otherwise
playing a script of the status item notification message for the subscriber.

11. The method as defined in claim 10 wherein if a scripted status item notification message is played for the subscriber, the method includes the additional steps of:
waiting for a reply/verification message from the subscriber; and
forwarding the reply/verification message to the notification system application platform.
